(19) United States
(12) Patent Application Publication
(10) Pub. No.: US 2002/0188682 A1
(43) Pub. Date: Dec. 12, 2002

(54) Method and system for manufacturing supply chain collaboration

(76) Inventors: Manlsh Jaln, Foster City, CA (US); Alice Wang, Burnaby (CA); Roger Chen, San Jose, CA (US); Russell Ho, Belmont, CA (US)

Correspondence Address: SAWYER LAW GROUP LLP, P.O. BOX 51418, Palo Alto, CA, 94303, US

(21) Appl. No.: 09/877,151

(22) Filed: Jun. 8, 2001

(51) Int. Cl. G06F 15/16

(52) U.S. Cl. 709/205; 709/202

(57) ABSTRACT

A method and system for manufacturing a supply chain collaboration is disclosed, the method and system comprising at least one customer including a first collaboration platform and at least one manufacturing partner (vendor) including a second collaboration platform. All CMS applications allow for peer-peer collaboration therebetween. A system and method in accordance with the present invention utilizes peer-to-peer technology to securely and reliably transfer the data between the companies and promotes a “push” mechanism where information is shared as soon as it becomes available.

### FIELD OF THE INVENTION

The present invention relates generally to a manufacturing process for semiconductors and more particularly to a system and method for efficiently manufacturing such devices.

### BACKGROUND OF THE INVENTION

In the past few years, with the advent of Internet technology, serious software applications have emerged which intend to harness the power of a “connected” society to improve productivity. Most companies today advertise their services via the web and the more advanced companies provide useful operational data on their websites. This has at a minimum improved the customer service aspects of the business by providing information needed by the customers to make better decisions, faster.

The goal is to enable companies who typically operate as semiconductor subcontractors during the manufacturing lifecycle to operate as a “virtual company”. There is important information that can be shared between these companies to optimize the supply chain and increase the efficiency of the production cycle. Because each company operates independently and has its own information systems, valuable data typically does not flow efficiently to the customers. This increases latency and delays response from the customer, causing potential delays in time to market.

There are several layers of technology when it comes to exchanging information. Technologies are available at the network level, infrastructure level and application level. It is desired to be able to efficiently tie these technologies together to optimize the time to market for a particular product.

Accordingly, what is needed is a system and method, which overcomes the above-identified problem. The present invention addresses such a need.

### SUMMARY OF THE INVENTION

A method and system for manufacturing a supply chain collaboration is disclosed, the method and system comprising at least one customer including a first collaboration application and at least one collaboration partner including a second collaboration application. The system can also include more collaboration partners which can include a third or more collaboration applications. Each connected application allows for peer-peer collaboration therebetween. A system and method in accordance with the present invention utilizes peer-to-peer technology to securely and reliably transfer the data between the companies and promotes a “push” mechanism where information is shared as soon as it becomes available.

### BRIEF DESCRIPTION OF THE DRAWINGS

FIG. 1 illustrates a collaborative menu server (CMS) system in accordance with the present invention.

FIG. 2 illustrates managing a project.

FIG. 3 describes the access request approval process.

FIG. 4 illustrates maintaining purchase orders.

FIG. 5 illustrates technical document sharing in accordance with the present invention.

FIG. 6 illustrates the process for viewing work in progress (WIP) data.

FIG. 7 illustrates providing reports using the CMS system.

FIG. 8 illustrates issue tracking in accordance with the present invention.

### DETAILED DESCRIPTION

The present invention relates generally to a manufacturing process for semiconductors and more particularly to a system and method for efficiently manufacturing such devices. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

Collaborative Manufacturing Server (CMS) system is a web based collaborative commerce suite, which allows different technologies to exchange information in an efficient manner. A centralized and web-based project server engine allows customers to manage projects on-line under a multi-user and personalized environment. The process of locating and acquiring required services is seamlessly streamlined through the use of an integrated CMS system. Customers can use a single browser window to locate service vendors, design document sets, and other information, including standard service cycle times. During the execution of the project, status updates are automatically sent to the customers. Other important documents related to the quality of the production are also automatically sent. Upon the completion of a project design cycle, the CMS system automatically delivers the manufacturing orders through a CMS system, which automates the customers' procurement tasks. A peer-to-peer technology is utilized to ensure that the sensitive data remains with concerned parties and not sent through a centralized hub mechanism.

The CMS system is a distributed application unlike other collaboration tools. A server resides inside the firewall of each collaboration participant and communication occurs directly between the participants.

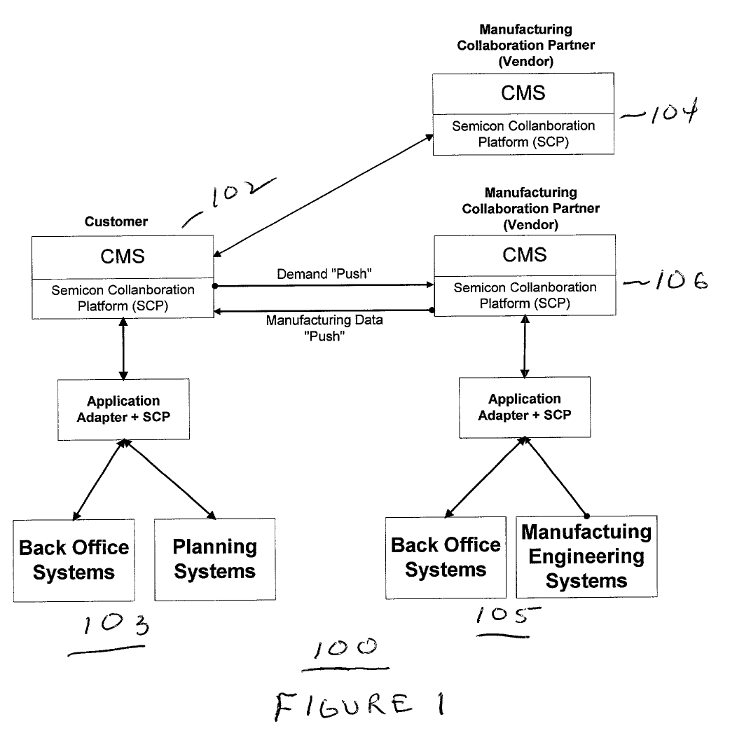

FIG. 1 illustrates a collaborative manufacturing server (CMS) system 100 in accordance with the present invention. In such a system, a customer provides information to and receives information from a plurality of partners. The customers and manufacturing partners each have their own CMS application 102, 104 and 106 respectively which allows for peer to peer collaboration therebetween.

The supplier and customer platforms 102 and 104 provide information to and receive information from their respective back office applications 103 and 105 using, for example, a Semicon Collaboration Platform which is provided with CMS. The CMS system provides the following features:

1. Project Management

Customers create a project for every integrated circuit that needs to be manufactured. Each project is a schedule of manufacturing tasks that need to be completed for the entire production cycle. Different partners perform these tasks. All the tasks are part of a single project regardless of which partner completes the tasks. When tasks are in progress, a status update is automatically shown to the customer via the peer to peer technology. Users can share the project information by adding other users to the project. To describe this feature refer now to the following description in conjunction with the accompanying figures.

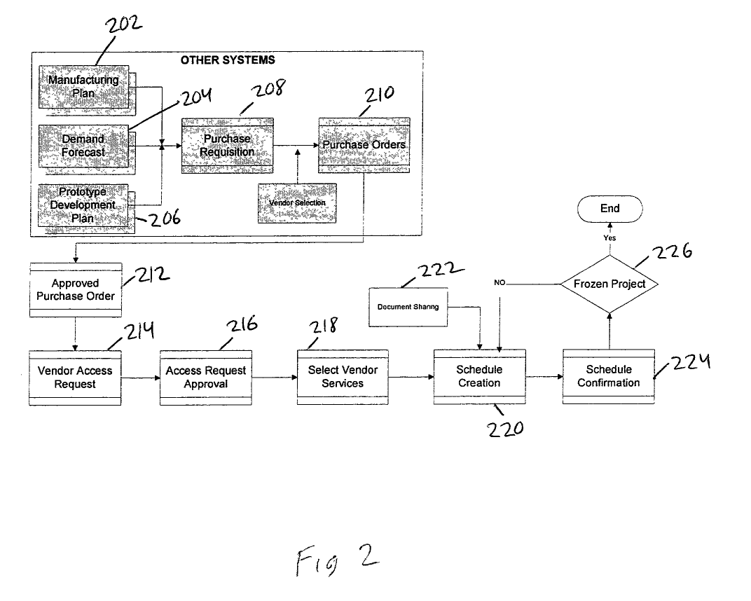

FIG. 2 illustrates managing a project. The other systems have their own manufacturing plan, demand forecasts and prototype development. These are inputs to a purchase requisition, via steps 202, 204 and 206. Purchase orders are then provided based on the purchase requisition, via step 208 and 210 Thereafter the purchase order is approved in the financial system. The approved purchase order number and other summary information is imported into CMS. Thereafter, a vendor access is requested within the CMS system, via step 214. Then the access request is approved, via step 214. After the access request is approved, then vendor services are selected, via step 216. Finally, from that selection of vendor services a schedule is created via document sharing, via steps 220 and 222. Thereafter, it is determined if there is scheduled confirmation, 224. If it is a frozen project or the project, via step 22, is completed, then the process is ended. However, if it is not frozen then the schedule creation step 220 is revisited.

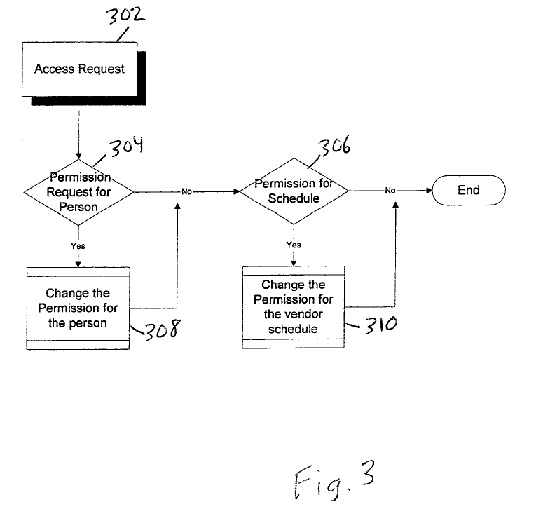

FIG. 3 describes the access request approval process. First, the access request is provided, via step 302. First, it is determined if the permission is granted for the request for the person, via step 304. If it is granted, then the permission for the person is changed, via step 308 If it is not granted, it is determined if there is a permission to schedule via step 306. If there is no permission to schedule after step 308, then end. If, on the other hand, there is a permission for schedule, change the permission for the vendor schedule, via step 310.

2. Purchase Order Maintenance

CMS imports the P.O data from the customer's financial system. There are two ways it can import the data. PO can be imported via a text file. Or it can be imported via an automated connection to the financial system. Summary purchase order information is captured and maintained in CMS. This purchase order information is automatically transferred to the service providers where it can import into the service provider's financial systems. All project data will be associated with the PO number for tracking purposes. To describe this feature refer now to the following description in conjunction with the accompanying figures.

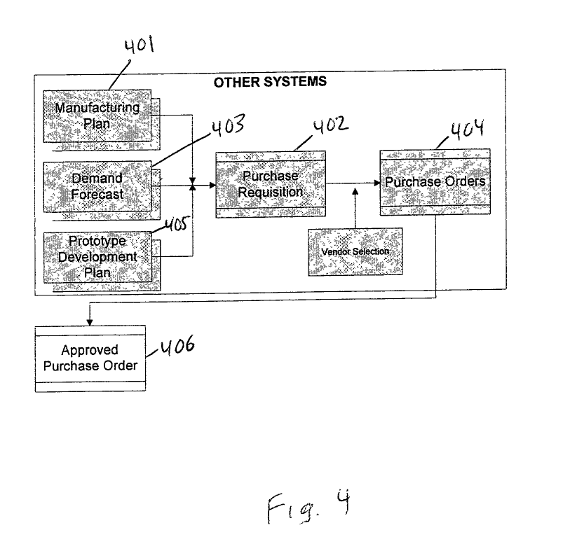

FIG. 4 illustrates maintaining purchase orders. The other systems have their own manufacturing plan 401, demand forecasts 403 and prototype development 404. These are inputs to a purchase requisition via step 402. Purchase orders are then provided based on the purchase requisition via step 404. Thereafter, the approved purchase order is imported into the CMS application via step 406.

3. Document Sharing

Customers and service providers share a number of technical documents. CMS allows the documents to be easily sent from the service providers to the customers. Revisions of the documents are automatically saved and updated on the customer's site. To describe this feature refer now to the following description in conjunction with the accompanying figures.

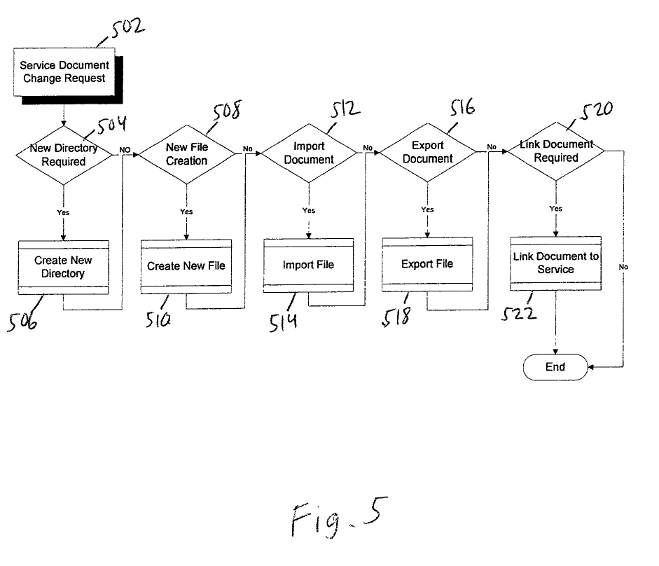

FIG. 5 illustrates document sharing in accordance with the present invention. First, the service document change request is provided, via step 502. It is first determined if a new directory is required, via step 504. If a new directory is required, then a new directory is created, via step 506. If none is required, or after step 506, then it is determined if a new file needs to be created, via step 508. If the answer is yes, then the new file is created, via step 510. If the answer is no, or after step 510, it is determined if a document must be imported, via step 512. If the answer is yes, then a file is imported, via step 514. If the answer is no, or after step 514, then it is determined if a document needs to be exported, via step 516. If the answer is yes, the file is exported, via step 518. If the answer is no, or after step 518 then it is determined if the link document is required, via step 520. If the answer to that is no, then end. If the answer is yes, then the document is linked to the service, via step 522.

4. WIP Data

One of the most important requirements from customers is the ability to view Work-In-Progress (WIP) data from the service provider's systems. Each service provider maintains the WIP data in their own formats. CMS allows easy connectivity to the service providers' WIP information system and the ability to transport the data to the customer's CMS application. Customers can view the WIP data in near real time (as soon as it becomes available) and in their own environment—they don't need to go to another website to view the information. This also gives them the ability to track planned vs. actual WIP information. To describe this feature refer now to the following description in conjunction with the accompanying figures.

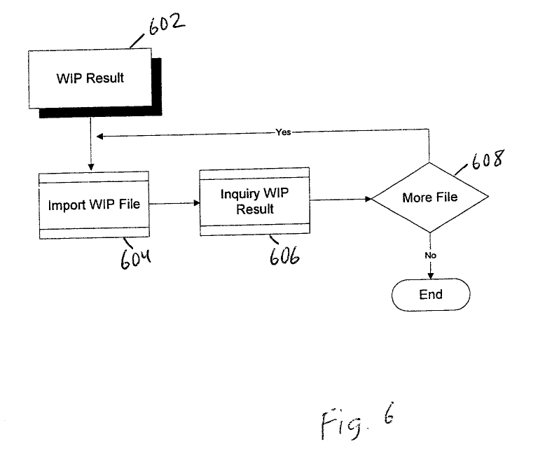

FIG. 6 illustrates the process for viewing work in progress (WIP) data. First, the WIP result is provided via step 602. Then the WIP file is imported, via step 604. Then there is an inquiry into the WIP result, via step 606. It is then determined if there are more files via step 608. If there are more files, then the above-identified steps 604-608 are repeated. If there are no more files, then the process is ended.

5. Generating Reports

CMS provides a customizable report generation tool. Customers and other partners in the “supply chain” want to view reporting information as soon as it becomes available. CMS provides the ability for the reports to be generated automatically from the data sent by the service providers to the customers. Customers can decide which other service providers to share this information. Improved availability of information increases the response time to solve potential problems, thereby increasing the time to market. To describe this feature refer now to the following description in conjunction with the accompanying figures.

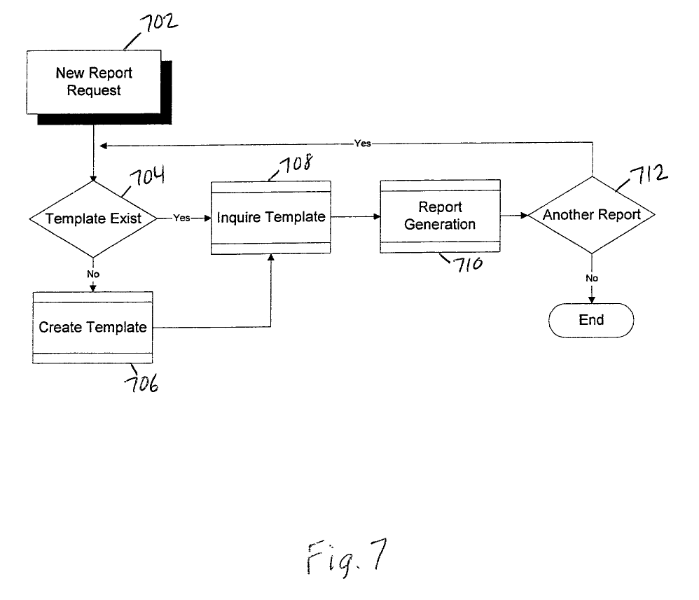

FIG. 7 illustrates providing reports using the CMS system. First, a new report request is provided, via step 702. Next, it is determined if a template exists, via step 704. If a template does not exist, then a new template is created, via step 706. If, on the other hand, a template does exist, or after the creation of the new template, inquiry is made about the template, via step 708. After the template is provided, then a report is generated via step 710 and then it is determined if another report needs to be generated, via step 712. If the answer is yes, then repeat the above-identified steps 704 - 712. If the answer is no, then the process is ended.

6. Issue Tracking

Very often issues arise during the production cycle and resolving the issue is not just the responsibility of one partner. It is a collaborative effort. Today, this is done using phone and fax. Using the on-line, near real-time Issue Tracking System in CMS, all partners can work to resolve the issues. Responses, including file attachments are automatically sent to all partners involved such that all partners can view the latest information available to help resolve the problems. This significantly reduces the time it takes to resolve potential problems thereby shortening the production time. To describe this feature refer now to the following description in conjunction with the accompanying figures.

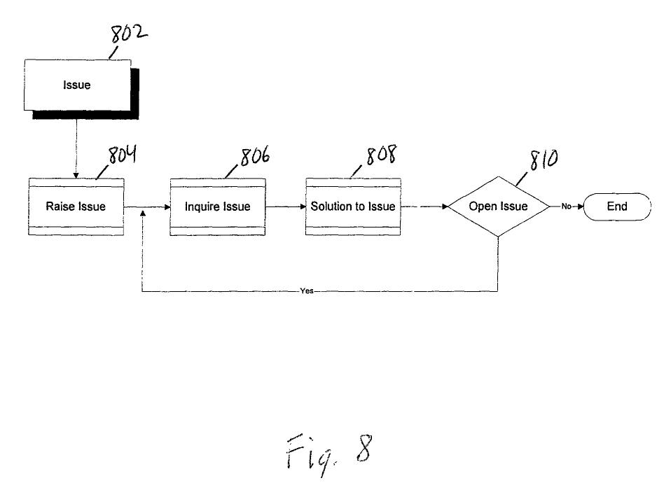

FIG. 8 illustrates issue tracking in accordance with the present invention. First an issue is provided, via step 802. Next, the issue is raised, via step 804. Next, the user studies issue, via step 806. A solution to the issue is then provided, via step 808. Next, it is determined if there are any open issues, via step 810. If there is an open issue, then the steps 806 and 808 are repeated. If there is no open issues, then the process is ended.

7. Advantages

A system and method in accordance with the present invention has many advantages. It improves manufacturing outsourcing processes for the semiconductor industry. It provides the ability to send WIP data in a “push” mechanism from the service providers to the customers using the above mentioned technologies. It provides the ability to send chip manufacturing schedule and process to all the outsourced vendors using the technologies mentioned above. It provides the ability to get lot status and progress throughout the semiconductor production lifecycle in near real-time using the above mentioned technologies.

It provides the ability of service providers to send engineering & other documents, with revisions, to the customers in an automated fashion using the above mentioned technologies.

It provides the ability of customers to send documents to the service providers with the project schedule using the above mentioned technologies. It provides the ability to manage issue resolution in a collaborative environment, using the peer-to-peer concept, above-mentioned technologies, specifically for semiconductor outsourcing process.

It provides the ability to send Wafer Maps, WAT reports, Yield information, etc. from the service providers to the customers in a collaborative concept described above using the technologies mentioned. It provides the application of peer-to-peer technology to improve collaboration for semiconductor outsourcing processes. Finally, it provides the application of java, technology, distributed application architecture, collaborative communication platform to improve collaboration for semiconductor outsourcing processes.

8. Conclusion

A centralized and web-based project server engine allows customers to manage projects on-line under a multi-user and personalized environment. The process of locating and acquiring required services is seamlessly streamlined through the use of an integrated CMS system. Customers can use a single browser window to locate service vendors, design document sets, and other information, including standard service cycle times. During the execution of the project, status updates are automatically sent to the customers. Other important documents related to the quality of the production are also automatically sent. Upon the completion of a project design cycle, the CMS system automatically delivers the manufacturing orders through a CMS system, which automates the customers' procurement tasks. A peer-to-peer technology is utilized to ensure that the sensitive data remains with concerned parties and not sent through a centralized hub mechanism.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A system for semiconductor manufacturing collaboration comprising:
at least one customer including a first collaboration application; and
at least one manufacturing partner including a second collaboration application;
wherein the first and second applications allow for peer-peer collaboration therebetween.

2. The system of claim 1 wherein each of the first and second applications provide information to and receive information from their respective back office applications.

3. The system of claim 1 wherein the at least one manufacturing partner comprises a plurality of manufacturing partners.

4. The system of claim 1 wherein work in progress (WIP) data is sent in a push fashion from manufacturing partner to the customer.

5. The system of claim 1 wherein the first and second collaboration applications include means for managing a project.

6. The system of claim 1 wherein the first and second collaboration applications means for document sharing.

7. The system of claim 1 wherein the first and second collaboration applications include means for viewing work in progress (WIP) data.

8. The system of claim 1 wherein the first and second collaboration applications includes means for providing reports.

9. The system of claim 1 wherein a chip manufacturing schedule can be sent to the manufacturing partner.

10. The system of claim 1 wherein the first and second collaboration applications include means for tracking issues.

11. The system of claim 1 wherein a lot status and progress of the semiconductor produce lifecycle can be obtained in near real-time.

12. The system of claim 3 wherein the plurality of manufacturing partners send engineering documents with revisions to the customer in an automated fashion.

13. The system of claim 3 wherein the customer sends documents to the plurality of manufacturing partner with a project schedule.

14. The system of claim 1 wherein issues are managed collaboratively by the applications.

15. The system of claim 3 wherein wafer maps, WAT reports, yield information are sent from the plurality of manufacturing partners to the customer.

16. The system of claim 1 wherein JAVA technology is utilized with the collaboration platforms.
